(19) United States
(12) Patent Application Publication
(10) Pub. No.: US 2008/0222438 A1
(43) Pub. Date: Sep. 11, 2008

(54) Apparatus For Automatically Detecting And Differentiating Between USB Host And Device

(76) Inventors: Peng-Fei Lin, Hsinchu (TW); Kuo-Chen Chuang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/682,886

(22) Filed: Mar. 7, 2007

(51) Int. Cl. G06F 1/00

(52) U.S. Cl. 713/340

(57) ABSTRACT

An apparatus for automatically detecting and differentiating between a USB host and a USB device is provided. In a device with a USB interface, the present invention is coupled with the VBUS pin of the USB interface of the device. By monitoring the voltage change on the VBUS pin, the present invention determines whether the external device connected through the USB interface is a USB host or a USB device. The apparatus for automatically detecting and differentiating between a USB host and a USB device of the present invention includes a voltage detection circuit and a voltage detector. The voltage detection circuit is coupled with the voltage detector and the VBUS pin of the USB interface. The voltage detection circuit can be a voltage splitter. The voltage of voltage detection circuit can be changed according to the voltage signal inputted externally from the VBUS pin of the USB interface. The voltage detector is used to detect the voltage change of node A of voltage detection circuit to determine whether the external device connected through the USB interface is a USB host or a USB device.

### FIELD OF THE INVENTION

The present invention generally relates to an apparatus for automatically detecting and differentiating between a USB host and a USB device, and more specifically to an apparatus for automatically detecting and differentiating between a USB host and a USB device by using a VBUS pin to connect to an external USB-interface device and monitoring the voltage change on the VBUS pin

### BACKGROUND OF THE INVENTION

The universal serial bus (USB) interface is turning into a standard interface for portable devices. However, the original design of USB is targeting PC host. Conventionally, USB is used as an interface between a PC host and a peripheral device. The peripheral devices cannot be connected to one another with USB interface. For example, as shown in FIG. 1, PDA 103, digital camera 104, USB keyboard 105, and USB mouse 106 are all connected to PC host 101 through hub 102a, 102b.

The Universal Serial Bus Implementers Forum (USB-IF) chose the client-server architecture in defining the USB architecture. That is, the more difficult and complicated processing are left to the server, i.e., PC, while keeping the clients, i.e., the peripherals, as simple as possible. The former is called USB host, and the latter is called USB device. However, as more and more USB devices are developed and the functionality of portable electronic devices improves, it becomes restrictive for some USB devices to stay connected to a USB host. Therefore, USB-IF, based on the original USB specification, defines a USB inter-connection standard, called On-The-Go (OTG).

USB OTG is not independent of USB2.0. Instead, USB OTG provides a way for the USB device to break off from USB host. The USB OTG 1.0 specification provides a concept of Dual-Role device. In other words, an OTG device can be used as a host in addition to as a device. Hence, a USB device can be used in conjunction with a USB OTG device to form a point-to-point client-server connection.

The USB OTG device uses a mini-AB connector, and an ID pin is added to the interface. The ID pin is used to identify which one of the two connected USB OTG devices is the controller, i.e., USB OTG host 201, and which one is the controlled, i.e., USB OTG device 210, as shown in FIG. 2. The ID pin 201a is “0” which tells the USB OTG device 201 to switch to the Host role, and ID pin 201b is NC keeps the OTG Device 202 in Device actor. As sown in FIG. 2, USB OTG host 201 supplies power through VBUS pin to USB OTG device 210.

The host in the USB OTG architecture is called device A, and the peripheral device is called device B, and the client/server relation, i.e., device A and device B, are determined by the connector. After two devices are connected, the client/server roles can be changed. In general, device A must supply power to device B. However, as device A is usually also a portable device with limited power supply, the power supply standard is modified from 100 mA to 8 mA, and the voltage from 4.4V to 5.25V.

As USB OTG must rely on the ID pin to determine the role each plays in the connection, it is inconvenient for the users who are not familiar with mini-AB connector as the user may confuse the setting of ID pin and the USB OTG devices may not function correctly.

Yet another problem is that although some USB-interfaced devices support both standard and mini-AB connectors, the power supply may cause conflict when a USB OTG device is connected to the VBUS pin of a standard USB host.

### SUMMARY OF THE INVENTION

The primary object of the present invention is to provide an apparatus for automatically detecting and differentiating between a USB host and a USB device. In a device with a USB interface, the present invention is coupled with the VBUS pin of the USB interface of the device. By monitoring the voltage change on the VBUS pin, the present invention determines whether the external device connected through the USB interface is a USB host or a USB device.

The apparatus for automatically detecting and differentiating between a USB host and a USB device of the present invention includes a voltage detection circuit and a voltage detector. The voltage detection circuit is coupled with the voltage detector and the VBUS pin of the USB interface.

The voltage detector detects the voltage changes in the voltage detection circuit to determine whether the external device connected through the USB interface is a USB host or a USB device. On the other hand, the conventional USB OTG must use the ID pin of the connector to differentiate a USB host and a USB device.

The voltage detection circuit can be a voltage splitter, including a first resistor R1 in series with a second resistor R2 between a voltage source and a ground, and a capacitor C1 in parallel with the second resistor R2. The two ends of the capacitor C1 are connected to node A between resistors R1 and R2 and the ground, respectively. The voltage of node A of voltage detection circuit can be changed according to the voltage signal inputted externally from the VBUS pin of the USB interface. The voltage detector is used to detect the voltage change of node A of voltage detection circuit to determine whether the external device connected through the USB interface is a USB host or a USB device.

According to the present invention, the two connected USB devices, either standard USB interface or USB OTG interface, can both communicate with each other. There is no conflict in the VBUS voltage even when two USB hosts are connected. When the present invention detects that the external device is a USB host, the present invention will adjust itself to a USB device. Similarly, when the present invention detects the external device is a USB device, the present invention adjust itself to a USB host.

When a USB-interfaced device with the present invention is connected to an external USB host, node A of the voltage detection circuit of the present invention is coupled with the VBUS pin of the USB. The VBUS pin of the USB host outputs a 5V voltage to node A, and charges the capacitor C1 of voltage detection circuit to increase the voltage at node A. The voltage detector detects the voltage increase at node A. Therefore, the present invention determines that the external device is a USB host, i.e., the server, and the USB-interfaced device adjusts itself to a USB device, i.e., the client.

On the other hand, when a USB-interfaced device with the present invention is connected to an external USB device, node A of the voltage detection circuit of the present invention is coupled with the VBUS pin of the USB. When the external USB device starts to operate, the voltage on the VBUS pin of the USB-interfaced device is drained, the capacitor C1 of voltage detection circuit discharges to decrease the voltage at node A. The voltage detector detects the voltage decrease at node A. Therefore, the present invention determines that the external device is a USB device, i.e., the client, and the USB-interfaced device adjusts itself to a USB host, i.e., the server.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional USB architecture with host and peripheral devices;

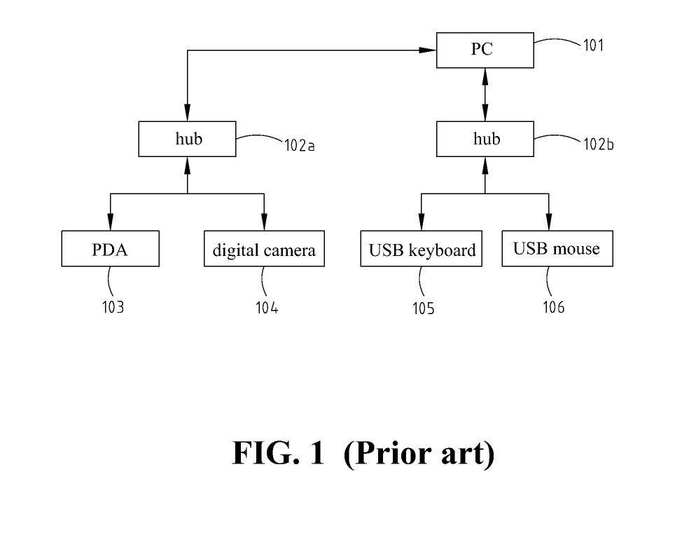

FIG. 2 shows a schematic view of two USB OTG devices using ID pin to differentiate host from device;

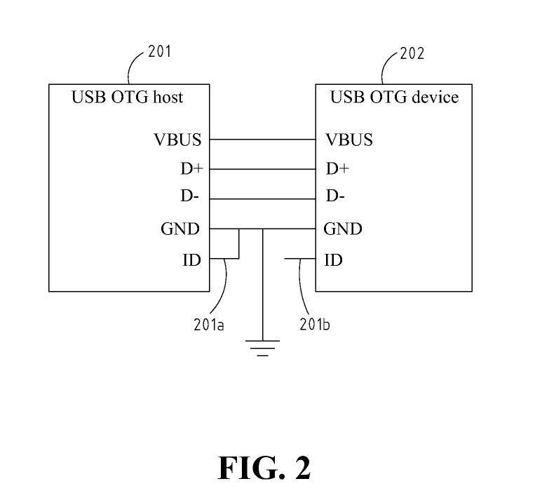

FIG. 3 shows a schematic view of an embodiment of the apparatus for automatically detecting and differentiating between a USB host and a USB device of the present invention;

FIG. 4 shows a schematic view of an embodiment of the voltage detection circuit of the present invention;

FIG. 5 shows a schematic view of an application of the present invention to a device connected to a USB host; and

FIG. 6 shows a schematic view of an application of the present invention to a device connected to a USB device.

### DETAILED DESCRIPTION OF THE PREFERRED EMBODIMENTS

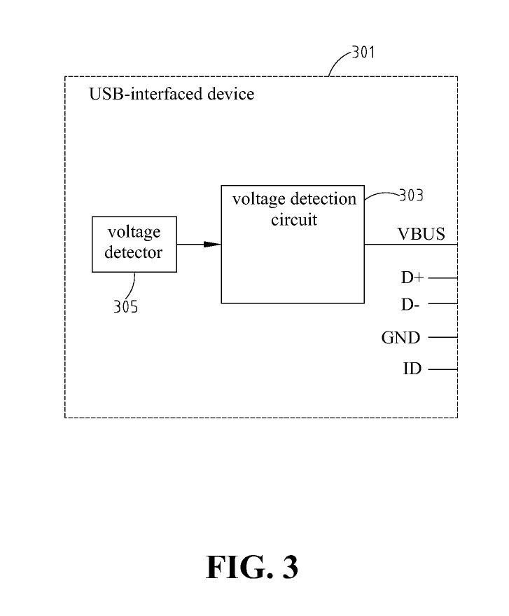

FIG. 3 shows a schematic view of an embodiment of the apparatus for automatically detecting and differentiating between a USB host and a USB device of the present invention. The present invention is applied in a device 301 with a USB interface. As shown in FIG. 3, the apparatus for automatically detecting and differentiating between a USB host and a USB device includes a voltage detection circuit 303 and a voltage detector 305. Voltage detection circuit 303 is coupled with voltage detector 305 and the VBUS pin of the USB interface, respectively.

The voltage of voltage detection circuit 303 can be changed according to the voltage signal of the VBUS pin of the USB interface, which receives the voltage signal from the VBUS pin of the external device. Voltage detector 305 detects the voltage change of voltage detection circuit 303 to determine whether the external device is a USB host or a USB device. On the other hand, the conventional USB OTG must use the ID pin of the connector to differentiate a USB host and a USB device

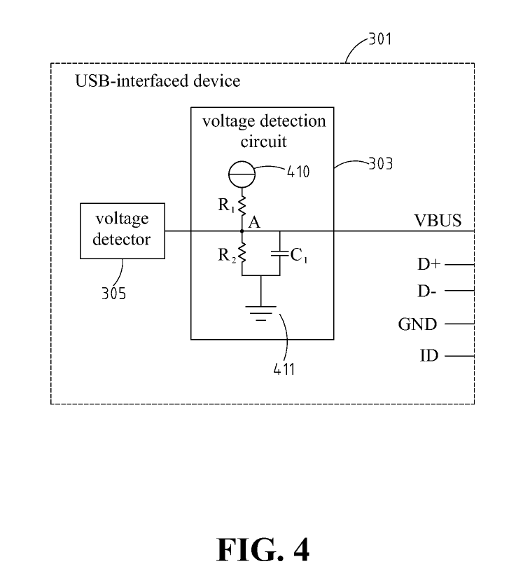

FIG. 4 shows a schematic view of an embodiment of the voltage detection circuit of the present invention. Without the loss of generality, the embodiment of the voltage detection circuit in FIG. 4 is a voltage splitter. As shown in FIG. 4, the present invention is applied in a device 301 with a USB interface. The present invention includes a voltage detection circuit 303 and a voltage detector 305. Voltage detection circuit 303 further includes a first resistor R1 in series with a second resistor R2 between a voltage power source 410 and a ground 411, and a capacitor C1 in parallel with the second resistor R2. The two ends of the capacitor C1 are coupled with node A between resistor R1 and resistor R2, and ground 411.

Node A of voltage detection circuit 303 is further coupled with voltage detector 305 and the VBUS pin of the USB interface, respectively. The voltage of node A of voltage detection circuit 303 can be changed according to the voltage signal inputted externally form the VBUS pin of the USB interface. Voltage detector 305 is used to detect the voltage change of node A of voltage detection circuit 303 to determine whether the external device connected through the USB interface is a USB host or a USB device.

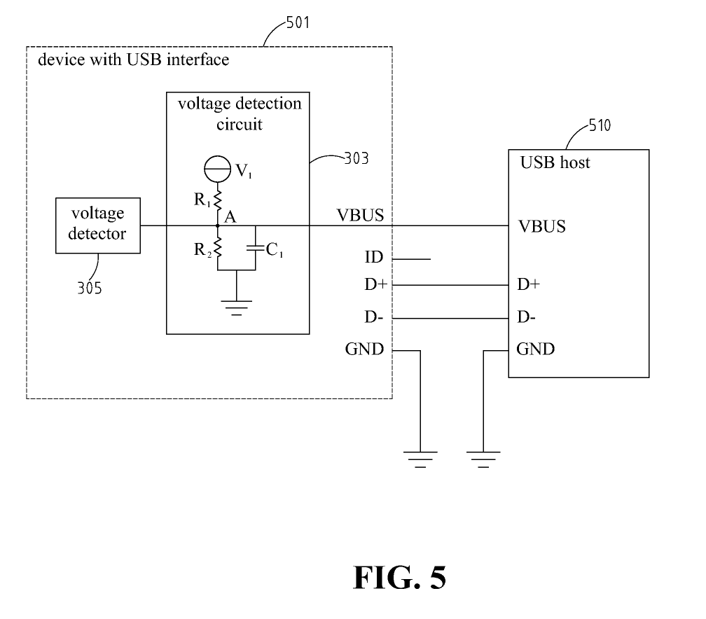

FIG. 5 shows a schematic view of an application of the present invention to a device connected to a USB host. As shown in FIG. 5, the present invention is applied to a device 501 with the USB interface. Device 501 is connected to a USB host 510. The present invention includes a voltage detection circuit 303 and a voltage detector 305. Voltage detection circuit is coupled with voltage detector 305 and the VBUS pin of the USB interface, respectively.

The voltage power supply V1 of voltage detection circuit 303 supplies 3.3V, resistor R1 is 8K Ohm, and resistor R2 is 25K Ohm. Before node A is coupled with USB host 510, the voltage at node A can be computed by (R2/R1+R2)*V1, i.e., 2.5V.

When device 501 is connected to USB host 510, the two VBUS pins of both USB interfaces are connected, and the VBUS pin of USB host 510 outputs a 5V voltage to node A of voltage detection circuit 303. As the voltage (5V) at VBUS pin is higher than the voltage (2.5V) at node A, capacitor C1 of voltage detection circuit 303 starts to charge to increase the voltage at node A. Then, voltage detector 305 detects that voltage at node A is higher than 2.5V, and determines the external device is a USB host. Therefore, device 501 adjusts itself to be a USB device.

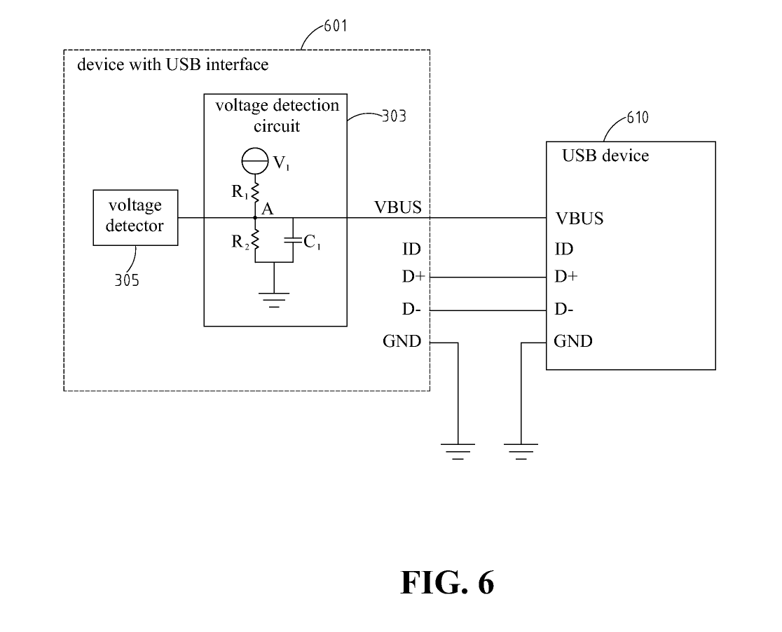

FIG. 6 shows a schematic view of an application of the present invention to a device connected to a USB device. As shown in FIG. 6, the present invention is applied to a device 601 with the USB interface. Device 601 is connected to a USB device 610. Node A of voltage detection circuit 305 is coupled with voltage detector 305 and the VBUS pin of the USB interface of device 601, respectively.

The voltage power supply V1 of voltage detection circuit 303 supplies 3.3V, resistor R1 is 8 K Ohm, and resistor R2 is 25 K Ohm. Before node A is coupled with USB device 610, the voltage at node A can be computed by (R2/R1+R2)*V1, i.e., 2.5V.

When device 601 is connected to USB device 610, the VBUS pin of USB device 610 does not output any voltage to node A of voltage detection circuit 303. When USB device 610 starts to operate, USB device 610 draws power from the VBUS pin of device 601, which causes capacitor C1 of voltage detection circuit 303 to discharge. The voltage at node A is decreased. Then, voltage detector 305 detects that voltage at node A is lower than 2.5V, and determines the external device is a USB device. Therefore, device 601 adjusts itself to be a USB host.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for automatically detecting and differentiating between a USB host and a USB device, applicable to a device with USB interface, said apparatus comprising:
a voltage detection circuit, coupled to a VBUS pin of said USB interface of said device; and
a voltage detector, coupled to said voltage detection circuit.

2. The apparatus as claimed in claim 1, wherein said USB interface is USB1.0, USB 1.1, USB 2.0, USB OTG or any combination of the above.

3. The apparatus as claimed in claim 1, wherein said voltage detector detects the voltage increase in said voltage detection circuit, and said device with USB interface adjusts itself to be a USB device.

4. The apparatus as claimed in claim 1, wherein said voltage detector detects the voltage decrease in said voltage detection circuit, and said device with USB interface adjusts itself to be a USB host.

5. The apparatus as claimed in claim 1, wherein said voltage detection circuit is a voltage splitter.

6. The apparatus as claimed in claim 5, wherein said voltage detection circuit further comprises a first resistor in series with a second resistor between a voltage source and a ground, and a capacitor in parallel with the second resistor, the two ends of said capacitor being connected to a node between said first resistor and said second resistor and said ground, respectively, said node further coupled with said VBUS pin of said device with USB interface.

7. The apparatus as claimed in claim 6, wherein said VBUS pin of said device with USB interface is coupled with said node of said voltage detection circuit, said capacitor charges to increase voltage at said node, said voltage detector detects the voltage increase and said device with USB interface adjusts itself to be a USB device.

8. The apparatus as claimed in claim 6, wherein said VBUS pin of said device with USB interface is coupled with said node of said voltage detection circuit, said capacitor discharges to decrease voltage at said node, said voltage detector detects the voltage decrease and said device with USB interface adjusts itself to be a USB host.
